(19) United States
(12) Patent Application Publication
(10) Pub. No.: US 2026/0014574 A1
(43) Pub. Date: Jan. 15, 2026

(54) Vehicular Fluid Spraying Assembly

(71) Applicant: Bobby Nami, San Antonio, TX (US)

(72) Inventor: Bobby Nami, San Antonio, TX (US)

(21) Appl. No.: 18/772,797

(22) Filed: Jul. 15, 2024

(51) Int. Cl. B05B 7/00; B05B 13/00

(52) U.S. Cl. CPC B05B 7/0018; B05B 13/005

(57) ABSTRACT

The vehicular fluid spraying assembly described herein is intended to defend against wildfires and similar conditions. It consists of a combination of a trunk line fluidly connected to one or more standpipes, and one or more water monitors with aspirating foam nozzle assemblies, wherein a user (e.g., a vehicle operator) can direct water and/or foam to the water monitor with aspirating foam nozzle assemblies, and thereby direct water and/or foam to wildfires and similar conditions.

### CROSS REFERENCES TO RELATED APPLICATION

Not applicable.

### FEDERALLY SPONSORED RESEARCH OR DEVELOPMENT

Not applicable.

### BACKGROUND OF THE INVENTION

### 1. Field of the Invention

The present invention is directed towards improving technology used when defending private and public property, and human and animal life, against the destructive forces of wildfires. This invention improves the technology currently used to combat wildfires and related dangerous occurrences.

### 2. Description of the Related Art

A variety of technologies are used in connecting with fighting wildfires. The following technologies have been used since the late 1800's which included, humans and water. Now fire trucks, land vehicles and a combination of distributing water, foams, aircraft and helicopters now use fire retardants powders and or water. Existing technologies fall short because they place humans too close to the dangerous conditions; the technologies are not sufficiently close to the dangerous conditions in order to be effective; or the technologies are otherwise ineffective or inefficient. Aircraft and helicopters cannot fly in high wind conditions. With this invention, it will revolutionize the way wildfires are fought and extinguished. Various embodiments of the invention can be used twenty-four hours a day.

### SUMMARY OF THE INVENTION

The present invention was developed to address the problems discussed above. The vehicular fluid spraying assembly described herein is intended to defend against wildfires and similar conditions. It consists of a combination of a trunk line fluidly connected to one or more standpipes, and one or more water monitors with aspirating foam nozzle assemblies, wherein a user (e.g., a vehicle operator) can direct water and/or foam to the-water monitor with aspirating foam nozzle assemblies, and thereby direct water and/or foam to wildfires and similar conditions. Water Monitor with an aspirating foam nozzle can shoot a stream of water or water/and or foam more than upwards of 150 feet in order to reach wildfires and similar conditions more efficiently and safely. This distance could be increased with greater pressure and/or sufficiently powered pumps, and related equipment.

### BRIEF DESCRIPTION OF THE SEVERAL VIEWS OF THE DRAWINGS

For an improved understanding of the present invention, and the advantages thereof, reference is made to the following descriptions taken in conjunction with the accompanying drawings. The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 is a perspective view of one embodiment of the invention.

FIG. 2 is a perspective view of the invention shown in FIG. 1, mounted and fluidly connected to an illustrative land vehicle.

FIG. 3 is a front view of the invention shown in FIG. 1 and FIG. 2, mounted and fluidly connected to the land vehicle illustrated in FIG. 4

FIG. 4 is a side view of a portion of the invention shown in FIG. 1.

The broken lines in the drawings illustrate portions of the vehicle that form no part of the claimed invention.

### DETAILED DESCRIPTION OF THE INVENTION

### 1. General Considerations

The present invention disclosure is for a vehicular fluid spraying assembly intended to defend private and public property, and human and animal life, against the destructive forces of wildfires. The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

### 2. Considerations Specific to the Invention

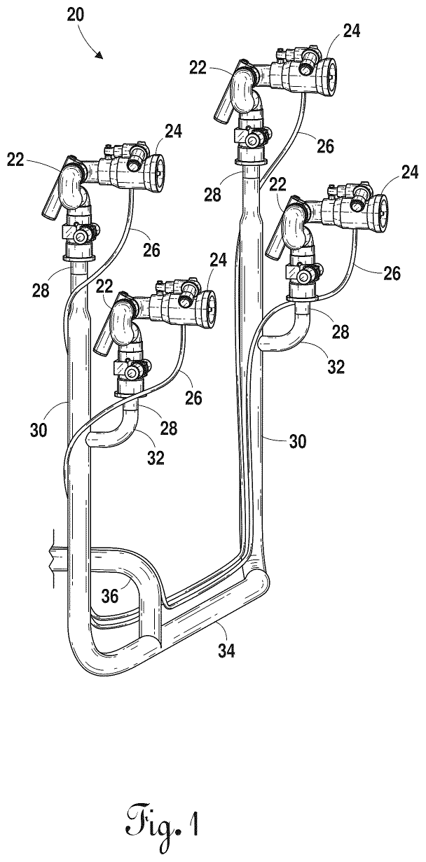

FIG. 1 illustrates the tree portion of the fluid spraying assembly 20 (the “tree portion” or “tree”). Tree 20 is made up, in relevant part of water monitors 22, aspirating foam nozzles 24, standpipes 30, branches 32, and trunk line 34. The relatedness of these several parts is discussed in greater detail below.

In this particular embodiment, the vehicle has two storage tanks: a 200 gallon foam tank, and a 9000 gallon water tank having a pump on the rear of the water tank (i.e., the distal end of the vehicle, assuming the tree 20. Water enters the tree 20 through water hose 36. It passes through trunk line 34 and proceeds upward through standpipes 30. The water continues to water monitors 22 and exits through aspirating foam nozzles 24. Two of the water monitors 22 are positioned vertically lower than the other water monitors 22. For the two lower water monitors 22, water leaves the standpipes 30 and passes through branches 32 before entering those water monitors 22. Each aspirating foam nozzle 24 in this embodiment draws foam by way of suction.

Foam enters the tree 20 through foam delivery tubes 26. In this embodiment, those tubes are 1.5 inches in diameter. The foam flows from the foam tank described above directly to aspirating foam nozzles 24.

In this embodiment, the water monitors 22 are removably attached to the standpipes 30 and the branches 32 by way of quick-release mechanisms 28.

In this embodiment, and by way of example, the user might configure the water monitor 22 from the Akron Brass Company's model number 3491 Severe-Duty Monitor with Electric Pattern Activation. In this embodiment, and by way of example, the user might configure the aspirating foam nozzle 24 from the Akron Brass Company's model number 4471 AkroFoam Master Stream Foam Nozzle with Electric Pattern Actuation.

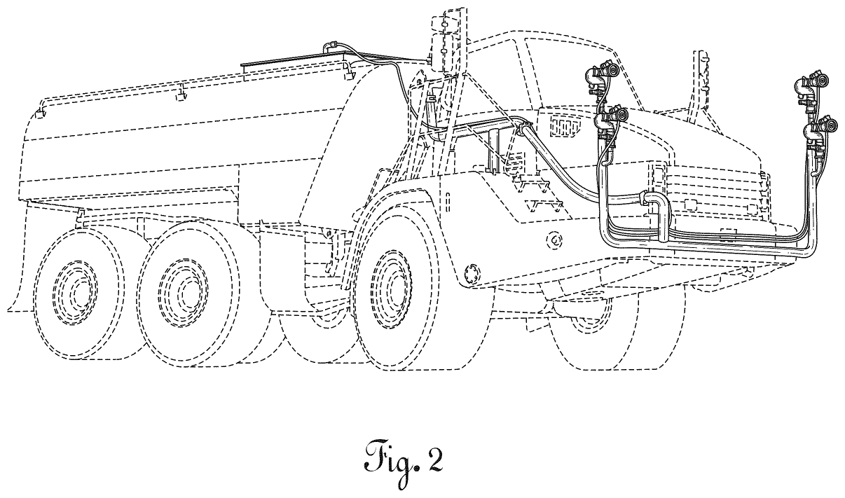

FIG. 2 illustrates tree 20 connected to a vehicle, such as an articulated prime mover (illustrated in broken lines to illustrate portions of the vehicle that form no part of the claimed invention). Although not shown, the water tank contains baffles to stabilize the water therein and to reduce cavitation as water pumps out of the tank and is delivered to the tree 20. Water exits the rear of the tank by way of a pump positioned on the rear exterior of the water tank.

A water line exiting the pump return the water to the top interior portion of the tank where it is carried through a pipe for the length of the tank. The pipe exits near the top of the front face of the water tank (the face nearest the driver's cabin). The water passes through a water hose from the exit of the front face of the tank until it reaches the right side of the driver's cabin, at which point it enters a steel pipe. The steel pipe is fixed in close proximity to the driver's side of the cabin. As the water passes the driver's side of the cabin it enters water hose 36, where it is eventually fed to the tree 20 at trunk line 34. The decision to use hosing versus steel piping is driven primarily by rigidity versus flexibility needed at that position along the trunk. Inside of the tank and along the driver's side of the cabin, little to known movement on the water conduit is necessary. By contrast, the space between the front face of the tank and the cabin moves based on the cabin turning. With that in mind, hosing is preferred because it can better accommodate that movement. In alternative embodiments, the steel piping could pass the passenger's side of the cabin.

In some embodiments, the invention will contain pressure controls and the invention will include a bleed line that returns excess water from the trunk line 34 to the water tank.

In this embodiment, the foam tank is positioned externally of the water tank. For the sake of illustration and example, the foam tank could be a 200-gallon external foam tank. Foam leaves the tank through the foam delivery tubes where it is eventually directed to one or more of the aspirating foam nozzles 24.

In this embodiment, the user might configure the assembly on an articulated prime mover, such as a Caterpillar® CAT745 Primar Mover. and incorporate two distinct tanks (e.g., water; foam).

In some embodiments, the cabin will contain at least two seats: a driver's seat and a passenger seat. The passenger seat will be in close proximity to a control system having four joysticks with buttons, allowing the passenger to rotate one or more of the water monitors with aspirating foam nozzles in at least two rotational axes relative to the tree 20 (and accordingly the trunk). This control will allow the passenger to change how close/far the water and/or foam sprays from the truck as well as whether the water and/or foam sprays immediately in front of the truck, to the sides of the truck or somewhere in between to extinguish the wildfire and similar conditions. In addition to rotating, the water monitor(s) move up, down, and from side to side.

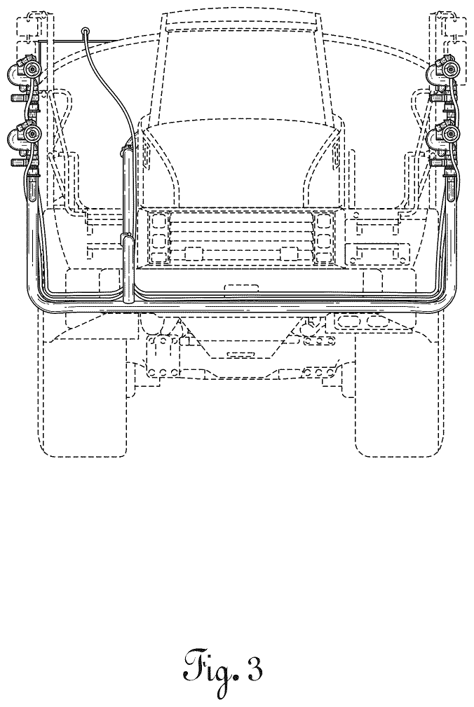

FIG. 3 illustrates a different view of tree 20 connected to the vehicle shown in FIG. 2 (illustrated in broken lines to illustrate portions of the vehicle that form no part of the claimed invention).

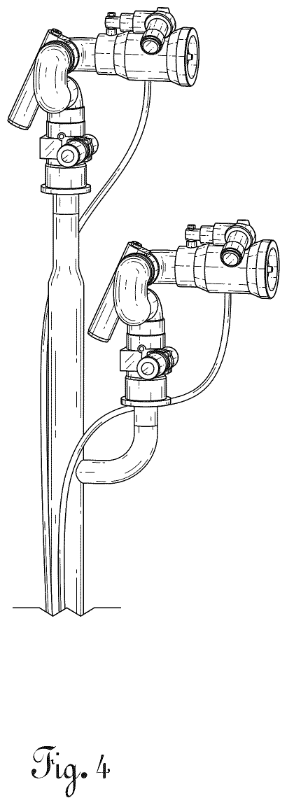

FIG. 4 is a side view of a portion of the invention shown in FIG. 1.

In some embodiments, the vehicle will further comprise a brush guard, wherein tree 20 is positioned between the vehicle's hood and the brush guard. Alternatively, the brush guard may be positioned lower/beneath tree 20 such that the brush guard is closer to the ground.

In some embodiments, the tree may exist such that the standpipes are positioned closer to one another. The standpipes are configured at the distance illustrated in the embodiment of FIG. 1 through FIG. 4 to optimize efficiency/operability while affording hood clearance. That is, the operator/user needs to access the engine and other operating units underneath the vehicle hood. In units wherein the standpipes are closer to one another, the operator might not be able to access those operating units underneath the vehicle hood.

In some embodiments, the standpipes might be taller or shorter, collectively, or individually. In some embodiments, there might be one, three, four, or more standpipes. In some embodiments, there might be one, two, three, five, or more water monitors with aspirating foam nozzles. In some embodiments, the standpipes might be adjustable relative to the trunk line. For example, in such an embodiment, the user could fold the standpipe(s) down from their upright position while not in use.

In some embodiments, the passenger will have access to more controls, such as flow rates of the water and foam, in the aggregate and/or individually among each of the nozzles.

In some embodiments, the invention will comprise a safety feature wherein if certain hazardous conditions exist, the invention will direct a combination of water and/or foam onto the vehicle in order to mitigate the impact of nearby flames on the vehicle. This will prolong the amount of time wherein operators can remain inside of the vehicle. The safety feature could be triggered manually or by automation (e.g., a smoke, temperature, or other sensor) if certain conditions exit.

This application has presented several embodiments of the present invention and discussed various devices. It is contemplated that these units and devices may exist in varying arrangements, combinations, and still reflect the spirit of the present invention. The prevent invention may be incorporated into other assemblies, which may have different capacities, capabilities, and/or applications.

The present invention is described above in terms of a preferred illustrative embodiment in which a specifically described vehicular fluid spraying assembly is described. Those skilled in the art will recognize that alternative constructions of such an apparatus, system, and method can be used in carrying out the present invention. Other aspects, features, and advantages of the present invention may be obtained from a study of this disclosure and the drawings, along with the appended claims.

### 3. Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating the vehicular fluid spraying assembly through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

We claim:

1. A spraying assembly comprising:
at least one standpipe extending from a fluid trunk line;
a water monitor with aspirating foam nozzle assembly fluidly connected to each of the at least one standpipes.

2. The spraying assembly of claim 1 further comprising:
at least one branching pipe extending from each of the at least one standpipe;
a water monitor with aspirating foam nozzle assembly fluidly connected to each of the at least one branching pipe.

3. A spraying assembly comprising:
two standpipes extending from a fluid trunk line;
at least one branching pipe extending from each of the two standpipes;
two water monitor with aspirating foam nozzle assemblies each of which is fluidly connected to each of the two standpipes; and
two water monitor with aspirating foam nozzle assemblies each of which fluidly connected to each of the at least one branching pipe.

4. The spraying assembly of claim 3 comprising a water hose fluidly connected to the fluid trunk line.

5. The spraying assembly of claim 3 comprising a foam delivery tube fluidly connected to each of the aspirating foam nozzle and an water monitor assemblies.

6. The spraying assembly of claim 3 comprising a control system in communication with each of the water monitors with aspirating foam nozzles assemblies.

7. The spraying assembly of claim 3 wherein each of the water monitor with aspirating foam nozzle assemblies comprises a quick release mechanism.
